(19) United States
(12) Patent Application Publication
(10) Pub. No.: US 2020/0310791 A1
(43) Pub. Date: Oct. 1, 2020

(54) ERROR CHECKING OF NOTEBOOK CODE BLOCKS

(71) Applicant: International Business Machines Corporation, Armonk, NY (US)

(72) Inventors: Kyle Gilbertson, Rochester, MN (US); Nicholas Todd Lawrence, Rochester, MN (US); Rafal Konik, Oronoco, MN (US); David Stanley Charron, Rochester, MN (US)

(21) Appl. No.: 16/366,099

(22) Filed: Mar. 27, 2019

(51) Int. Cl. G06F 8/75; G06F 8/20; G06F 8/30; G06F 8/74

(52) U.S. Cl. CPC G06F 8/75; G06F 8/74; G06F 8/37; G06F 8/20

(57) ABSTRACT

Proofing computer code in code blocks of an electronic computing interface based on generated dependency information between at least some related code blocks. When executing one or more of the code blocks, the dependency information is generated which tracks one or more of information associated with a user's actions, defined variables, defined functions, called functions, and associated imported data. A notification is displayed in the electronic computing interface to indicate when one or more or inconsistencies exist between related code blocks based on the dependency information.

### BACKGROUND

The invention relates generally to electronic computing interfaces for interactive programming and, more particularly, to generating and tracking dependency information between related code blocks.

Programming notebooks are software tools, often used in analytics applications, to run code, import data, capture output, hold documentation, and share that information. A notebook is divided in a logical manner into separate code and documentation blocks. While developing the notebook, rather than running code blocks in the notebook from top to bottom, a user can run code blocks out of sequence. The ability to run code blocks out of sequence allows for rapid and flexible prototyping and experimentation. Also, it is typical to load, cleanse and analyze data within a notebook. In order to fix a bug, the code must be revised or updated and then re-executed in one or more code blocks in order for any changes to take effect. Otherwise, a bug found while cleansing data can affect the quality of the analysis results. However, users often forget to re-execute the code and their analysis will be incorrect. Also, because code blocks can be executed in any order, it is difficult to remember dependencies between code blocks resulting in inaccurate results. What is needed is improved mistake proofing utilizing enhanced dependency information.

### SUMMARY

According to a non-limiting embodiment, a computer implemented method for proofing computer code is provided. The method includes developing an electronic computing interface having a plurality of code blocks, wherein the code blocks are related to one another in the development of a computer program, and executing one or more of the plurality of code blocks of the electronic computing interface. The method also includes generating dependency information between at least some of the code blocks of the electronic computing interface, wherein the dependency information tracks at least one of information associated with a user's actions, defined variables, defined functions, called functions, and associated imported data. The method then includes displaying a notification in the electronic computing interface, wherein the notification indicates one or more problems between code blocks regarding the dependency information.

According to another non-limiting embodiment, a computer system for mistake proofing computer code while developing a computer program is provided. The computer system includes an electronic computing interface with a plurality of related code blocks and stored dependency information generated from the execution of one or more of the code blocks. The dependency information tracks information associated with a user's actions while developing the computer program. A displayed notification in the electronic computer interface indicates when one or more problems or inconsistencies exist between code blocks based on the dependency information.

According to yet another non-limiting embodiment, a computer program product is provided. The computer program product includes a computer readable storage medium having program instructions embodied therewith, the program instructions executable by a computer processor to cause the computer processor to perform a method for proofing computer code. A non-limiting example of the method includes providing an electronic computing interface having a plurality of code blocks, wherein the code blocks are related to one another in the development of a computer program, and executing one or more of the plurality of code blocks of the electronic computing interface. The method performed by the computer processor also includes generating dependency information between at least some of the code blocks of the electronic computing interface, wherein the dependency information tracks information associated with a user's actions. The method then includes displaying a notification in the electronic computing interface, wherein the notification indicates one or more problems between code blocks regarding the dependency information.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings, in which:

FIG. 1 is a block diagram illustrating a computer system capable of implementing an electronic computing interface for developing a computer program in accordance with various embodiments of the invention;

FIGS. 2A and 2B are block diagrams illustrating an exemplary electronic notebook computing interface having computing code, documentation and results for demonstrating how to implement one or more embodiments of the present invention; and

FIG. 3 is a flow diagram illustrating a method for proofing computer code according to one or more embodiments of the present invention.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computer systems and specific computer programs to implement the various technical features described herein are well known. Accordingly, in the interest of brevity, many conventional implementation details are only mentioned briefly herein or are omitted entirely without providing the well-known system and/or process details.

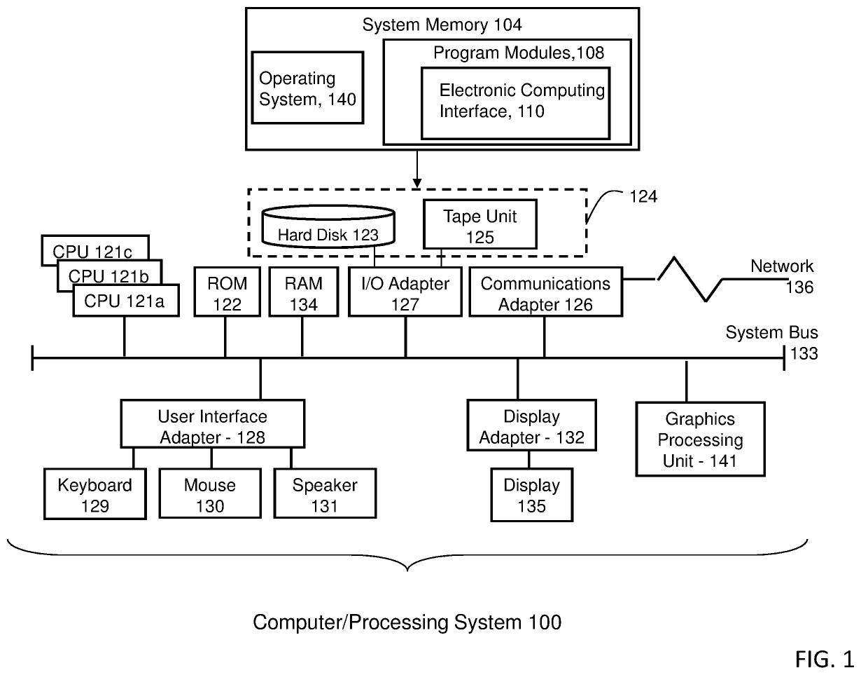

Referring now to FIG. 1, a computer system 100 is illustrated according to a non-limiting embodiment. In FIG. 1 the computer system 100 is shown in the form of a general-purpose computing device, which also may be referred to as a processing device, but may otherwise be, for example, a mobile telephone, a smartphone, a tablet personal computer, a laptop computer, and the like, for implementing the teachings herein.

The components of computer system 100 may include, but are not limited to, one or more central processing units (processors) 121a, 121b, 121c, etc. (collectively or generically referred to as processor(s) 121). In one or more embodiments, each processor 121 may include a reduced instruction set computer (RISC) microprocessor. Processors 121 are coupled to system memory (RAM) 134 and various other components via a system bus 133. Read only memory (ROM) 122 is coupled to the system bus 133 and may include a basic input/output system (BIOS), which controls certain basic functions of computer system 100.

FIG. 1 further depicts an input/output (I/O) adapter 127 and a network adapter 126 coupled to the system bus 133. I/O adapter 127 may be a small computer system interface (SCSI) adapter that communicates with a hard disk 123 and/or tape storage drive 125 or any other similar component. I/O adapter 127, hard disk 123, and tape storage device 125 are collectively referred to herein as mass storage 124.

Still referring to FIG. 1, depending on the configuration and type of computer system 100, system memory 104 comprises, but is not limited to, volatile storage (e.g., random access memory), non-volatile storage (e.g., read-only memory), flash memory, or any combination of such memories. According to an aspect, the system memory 104 includes an operating system 140 and one or more program modules 108 suitable for running software applications. The operating system 140, for example, is suitable for controlling the operation of the computer system 100. Operating system 140 may be stored in mass storage 124. However, the operating system 140 may also be stored in RAM 134 of the computer system 100. Operating systems according to embodiments of the present invention include, for example, UNIX™, Linux™, Windows 10™, and IBM's i™.

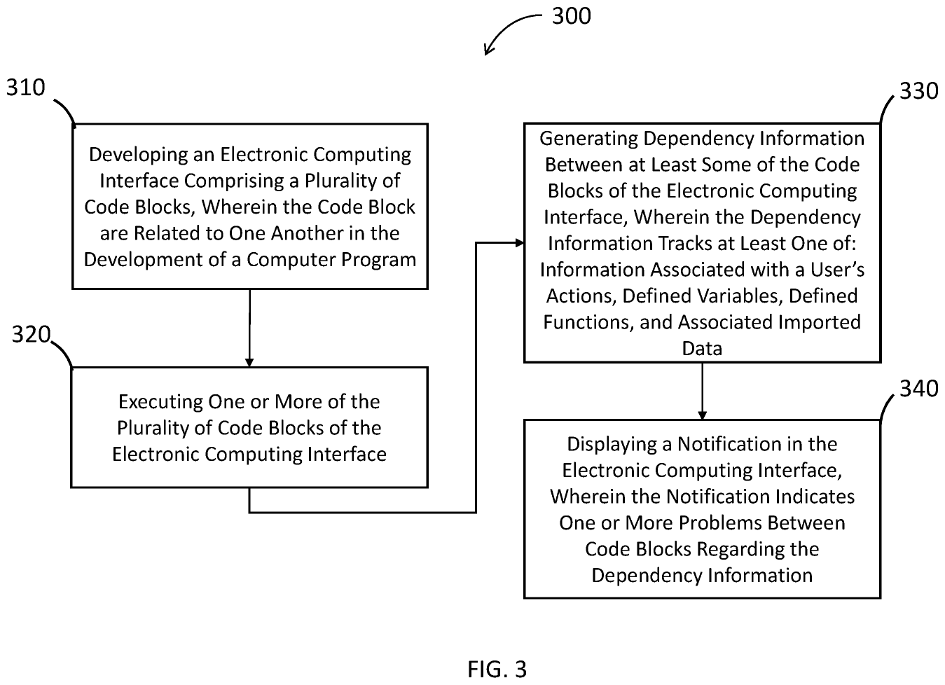

According to an aspect, the program modules 108 include an electronic computing interface module 110 for providing an interactive development environment which may be referred to simply as a programming environment. Also, in one or more embodiments, the electronic computing interface may be referred to as a notebook interface, computational notebook, or simply a notebook and may be used for interactive computing across different programming languages. For example, a notebook may be an open-source web application that allows the creation and sharing of documents that contain live code, equations, visualizations, and narrative text. Other interpretive or interactive command environments may be utilized such as SQL scripting tools, interactive Bash shells or interactive debugging tools where a user can input commands on the fly. The notebook is used to load, cleanse and analyze data and may access a data repository or a database. While executing, the program modules 108 (e.g., electronic computing interface module 110) perform processes including, but not limited to, one or more of the stages of the method 300 illustrated in FIG. 3.

A network adapter 126 interconnects bus 133 with an outside network 136 enabling the computer system 100 to communicate with other such systems. A screen (e.g., a display monitor) 135 is connected to system bus 133 by display adaptor 132, which may include a graphics adapter to improve the performance of graphics intensive applications and a video controller. In one embodiment, adapters 126, 127, and 132 may be connected to one or more I/O busses that are connected to system bus 133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 133 via user interface adapter 128 and display adapter 132. A keyboard 129, mouse 130, and speaker 131 all interconnected to bus 133 via user interface adapter 128, which may include, for example, a Super I/O chip integrating multiple device adapters into a single integrated circuit.

In exemplary embodiments, the computer system 100 includes a graphics processing unit 141. Graphics processing unit 141 is a specialized electronic circuit designed to manipulate and alter memory to accelerate the creation of images in a frame buffer intended for output to a display. In general, graphics processing unit 141 is very efficient at manipulating computer graphics and image processing and has a highly parallel structure that makes it more effective than general-purpose CPUs for algorithms where processing of large blocks of data is done in parallel.

Thus, as configured in FIG. 1, the computer system 100 includes processing capability in the form of the processors 121, storage capability including RAM 134 and mass storage 124, input means such as keyboard 129 and mouse 130, and output capability including speaker 131 and display 135. In one embodiment, a portion of RAM 134 and mass storage 124 collectively store the operating system 140 to coordinate the functions of the various components shown in FIG. 1.

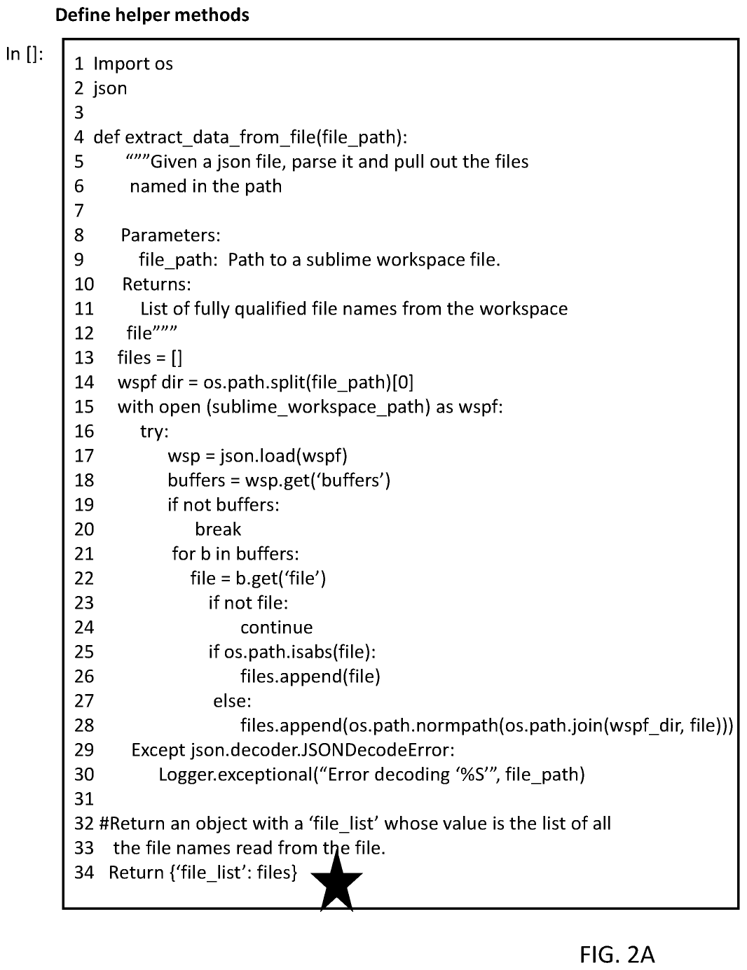

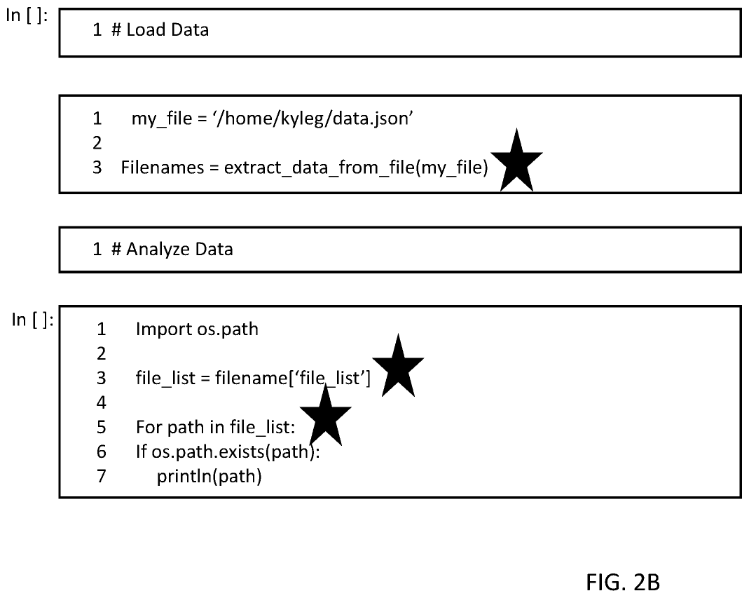

FIGS. 2A and 2B depict block diagrams illustrating an exemplary electronic notebook having computing code, documentation and results for demonstrating how to implement one or more embodiments of the present invention. The notebook is a software tool, often used in analytics applications, used to run code, import data, capture output, hold documentation, and easily share that information. The notebook is divided into separate documentation or code blocks developed in a logical order such as top to bottom. While a new notebook is developed, a user/developer can also run code blocks out of sequence. In either case, the notebook allows for rapid prototyping, experimentation, and resolution of problems.

However, because of the flexibility afforded by the notebook in developing code and, in particular, the ability to revise or update code and then re-execute fewer than all of the code blocks at a time, or none at all, sometimes the revisions or updates do not completely take effect through the entire program being developed. Thus, a bug found while cleansing data can affect the quality of the analysis results.

In FIG. 2A there is a particular line of code highlighted with a star. FIG. 2B also includes three stars in close proximity of particular lines of code. The stars are indicators indicating where potential problems exist in the code of the program being developed in the notebook. Although a star is used, other shapes, colors or methods such as highlighting may be used as indicators for indicating or providing notification where potential problems exist. Notifications could be presented in the same manner as conventional errors. For example, notifications could be presented in the same window as the errors or in a popup or other list of errors. The dependency-related errors may indicate a different type than conventional errors. In any case, the notifications are preferably displayed in proximity of the code in code blocks corresponding with potential problems.

For example, if all of the code of the notebook is executed once, and the name of a property is changed from ‘file_list’ to ‘files’ in the return value of method ‘extract_data_from_file’ (the star at the bottom of FIG. 2A), and then re-execute the code block with that method, then the data in memory that is still using the old data from the first execution of all the code blocks (the uppermost star in FIG. 2B). Therefore, the code in the code block corresponding with uppermost star in FIG. 2B should be executed again. Otherwise, if the notebook is closed and subsequently reopened, an error will result because of the inconsistent property name. The two bottommost stars in FIG. 2B indicate where other problems potential exists if changes were made to the data format returned by the method.

In one or more embodiments, analyzers can be used in order for the notebook to store and track data for generation and identification of dependency information between related code blocks based on code that is newly written, revised or altered after the last execution of the code in the code blocks. In other words, the newly written code or code that has been revised or altered has not yet been re-executed while the user continues to develop the notebook. The dependency information tracks information associated with a user's actions while developing the program, defined variables, defined functions, called functions and associated imported data. Upon re-execution of one or more code blocks, any dependency information associated with the re-executed blocks is updated. While executing and re-executing some of the cells of the program that is being developed, some of the dependency information may be associated with potential errors in cell blocks. Because the program is still being developed, new code is being written and revised, and code blocks are not all being executed simultaneously, error codes may have not yet been generated despite the generation of and updating of the dependency information.

The dependency information is used to generate notifications to the user to warn the user of potential problems as they appear as a result of the new code or as a result of the code that has been revised or altered. The dependency information can include links to particular source code within relevant code blocks. Static analyzers can be used when a user changes the behavior of a function or alters the format of the data it returns but the execution of the function was neglected. Dynamic analyzers can be used to detect basic state information such as data type and variable naming. Dynamic analysis can also detect changes to the type, size, existence, value or behavior of resources. In one or more embodiments, assistance can be provided via the electronic computing interface for resolving notifications or errors utilizing the dependency information.

A code block using a method, the results of the method (cleansed data), or a variable defined in some other code block could have additional information about the state of that data as was last used. This additional information can be used to detect and deal with changes to that state. Thus, the notebook can warn the user that a code block contains a dependency that has not been met or has been altered that affects the behavior of another code block. The parameters passed from a code block to another can be saved as dependency information so that the notebook then knows that a given function can change the parameters or that the call to the function depends on the data type, for example, of the input parameter. This can be captured as the user executes one or more code blocks, but not all, or this could be determined from static analysis or a combination thereof. Also, for complex programs, a number of possible relationships could affect the code. Therefore, the most likely possible errors based on analysis or user preference may be indicated to the user for the portion of code that has been executed by the user.

In one or more embodiments, code could be parsed out that has not yet been executed in order to provide more information to help the user find a code block that might resolve one or more current potential errors. Also, in another embodiment, local dependency data could be combined with dependency data and changes to that dependency data from another computing system. A program that works with relational data also instrumented with dependency tracking could share information so the notebook can identify source code affected by recent changes to the data model. A database management system can keep detailed logs of alternations to the database which may be implemented as a plugin to a notebook.

In one or more embodiments, plugins may be used to help the notebook better understand or more efficiently produce or process dependency information for third party libraries or data models. This includes commonly-used libraries like Pandas, Matplotlib, R's ggplot, tidyverse, or even a programmer's domain-specific data model or custom code. In another embodiment, the dependency information of a poorly organized program could be used to determine how to rearrange the code blocks in a more logical way. Alternatively, the dependency information can be used to suggest changes in the code blocks to improve the way the code runs or how it is organized. It may be suggested that multiple blocks are combined or a particular block be separated in order to more easily maintain the program.

In another embodiment, the dependency information could be used to offer assistance to the user to resolve errors. This might include simply showing the most recently executed code, per a recent edit to the code. The notebook may offer an option to change the code back to one of those states, or generate other options for changes to the code. The code to change may be in another code block. For example, a data element that was renamed in one code block and referenced in another where the references can be updated. Or the solution may be to execute the code block to bring it consistent with the rest of the code blocks.

Upon saving a program being developed to a file, some or all of the dependency information can be saved to be used the next time the program is opened up. This saves time in having to rebuild the dependency information of the relationships between code blocks. Also, this avoids the situation where the last session gave one result and then opening the program and executing all the code blocks giving a different result. Some of the dependency information would be invalid now that the in-memory state of the program was lost. But the notebook utilizing the saved dependency information as some state information is still relevant might reveal valid problems from the previous session that must be fixed.

Turning now to FIG. 3, a computer implemented method 300 for proofing computer code is illustrated according to a non-limiting embodiment. The flow diagram of FIG. 3 illustrates the method 300 that includes process block 310 for developing an electronic computing interface comprising a plurality of code blocks, wherein the code blocks are related to one another in the development of a computer program. The method 300 also includes process block 320 for executing one or more of the plurality of code blocks of the electronic computing interface. The method 300 then includes process block 330 for generating dependency information between at least some of the code blocks of the electronic computing interface, wherein the dependency information tracks at least one of: information associated with a user's actions, defined variables, defined functions, called functions, and associated imported data. Also, the method includes process block 340 for displaying a notification in the electronic computing interface, wherein the notification indicates one or more problems between code blocks regarding the dependency information.

The computer implemented method 300 may also include one or more other process blocks. In one or more embodiments, the method 300 can include where the electronic computing interface is a notebook and wherein executing one or more of the code blocks comprises executing less than all of the code blocks. The method 300 can also include updating code in one or more of the plurality of code blocks, re-executing one or more of the plurality of code blocks, and updating the dependency information. Also, the method 300 can include the dependency information associating a potential error with one or more of the plurality of code blocks. The method 300 can also include where the dependency information comprises one or more links to source code within one or more code blocks.

The computer implemented method 300 may also include where an error has not yet been generated in the code blocks regarding the dependency information. The method 300 may include displaying the notification in proximity of code in a particular code block corresponding with the one or more problems. The method 300 may also include where executing the one or more code blocks comprises executing the one or more of the code blocks out of sequence. The method 300 can also include loading data into one or more blocks of the electronic computing interface, cleansing the loaded data, and analyzing the cleansed data. The method 300 can include where one or more code blocks were not executed simultaneously and, in response to receiving the notification, utilizing the generated dependency information to identify the one or more problems between code blocks regarding the dependency information, re-executing one or more code blocks, and updating the dependency information.

Various technical benefits are achieved using the system and methods described herein, including the capability of providing enhanced performance for applications with exclusive access to the co-processors while also allowing applications that do not need performance access to accelerators when shared access is available. In this manner, the computer system can realize performance gains through the use of co-processors in the system, thereby improving overall processing speeds.

The present invention may be a system, a computer implemented method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention.

In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for proofing computer code, the method comprising:
developing an electronic computing interface comprising a plurality of code blocks, wherein the code blocks are related to one another in the development of a computer program;
executing one or more of the plurality of code blocks of the electronic computing interface;
generating dependency information between at least some of the code blocks of the electronic computing interface, wherein the dependency information tracks at least one of:
information associated with a user's actions;
defined variables;
defined functions;
called functions; and
associated imported data; and
displaying a notification in the electronic computing interface, wherein the notification indicates one or more problems between code blocks regarding the dependency information.

2. The computer implemented method of claim 1 wherein the electronic computing interface is a notebook and wherein executing one or more of the code blocks comprises executing less than all of the code blocks.

3. The computer implemented method of claim 1 further comprising updating code in one or more of the plurality of code blocks, re-executing one or more of the plurality of code blocks, and updating the dependency information.

4. The computer implemented method of claim 1 wherein the dependency information associates a potential error with one or more of the plurality of code blocks.

5. The computer implemented method of claim 1 wherein the dependency information comprises one or more links to source code within one or more code blocks.

6. The computer implemented method of claim 1 wherein an error has not yet been generated in the code blocks regarding the dependency information.

7. The computer implemented method of claim 1 wherein the notification is displayed in proximity of code in a particular code block corresponding with the one or more problems.

8. The computer implemented method of claim 1 wherein executing the one or more code blocks comprises executing the one or more of the code blocks out of sequence.

9. The computer implemented method of claim 1 further comprising loading data initiated by one or more blocks of the electronic computing interface, cleansing the loaded data, and analyzing the cleansed data.

10. The computer implemented method of claim 1 wherein one or more code blocks were not executed simultaneously and, in response to receiving the notification, utilizing the generated dependency information to identify the one or more problems between code blocks regarding the dependency information, re-executing one or more code blocks, and updating the dependency information.

11. A computer system for mistake proofing computer code while developing a computer program, the computer system comprising an electronic computing interface comprising a plurality of related code blocks and stored dependency information generated from execution of one or more of the code blocks, wherein the dependency information tracks information associated with a user's actions while developing the computer program, and a displayed notification in the electronic computing interface indicating one or more problems between code blocks regarding the dependency information.

12. The computer system of claim 11 wherein the dependency information further tracks at least one of:
defined variables;
defined functions;
called functions; and
associated imported data.

13. The computer system of claim 11 wherein the electronic computing interface is a notebook and wherein less than all of the code blocks have been executed.

14. The computer system of claim 11 wherein the dependency information associates a potential error with one or more of the plurality of code blocks.

15. The computer system of claim 11 wherein an error has not yet been generated in the code blocks regarding the dependency information.

16. The computer system of claim 11 wherein one or more of the plurality of code blocks has been executed out of sequence.

17. The computer system of claim 11 wherein one or more code blocks were not executed simultaneously and, in response to receiving the notification, utilizing the generated dependency information to identify the one or more problems between code blocks regarding the dependency information, re-executing one or more code blocks, and updating the dependency information.

18. A computer program product comprising a computer readable storage medium having program instructions embodied therewith, the program instructions executable by a computer processor to cause the computer processor to perform a method for proofing computer code, the method comprising:
providing an electronic computing interface comprising a plurality of code blocks, wherein the code blocks are related to one another in development of a computer program;
executing one or more of the plurality of code blocks of the electronic computing interface;
generating dependency information between at least some of the code blocks of the electronic computing interface, wherein the dependency information tracks information associated with a user's actions; and
displaying a notification in the electronic computing interface, wherein the notification indicates one or more problems between code blocks regarding the dependency information

19. The computer program product of claim 18 wherein an error has not yet been generated in the code blocks regarding the dependency information and executing the one or more code blocks comprises executing a plurality of the code blocks, but not all of the code blocks, out of sequence.

20. The computer program product of claim 18 wherein assistance is provided in resolving notifications utilizing the dependency information.
